(19) United States
(12) Patent Application Publication
(10) Pub. No.: US 2001/0047431 A1
(43) Pub. Date: Nov. 29, 2001

(54) HAVi-VHN bridge solution

(76) Inventor: Edward B. Eytchison, Milpitas, CA (US)

Correspondence Address: Townsend and Townsend and Crew, 8th Floor, Two Embarcadero Center, San Francisco, CA, 94111, US

(21) Appl. No.: 09/780,289

(22) Filed: Feb. 8, 2001

Related U.S. Application Data
(60) Provisional application No. 60/181,406, filed on Feb. 9, 2000.

(51) Int. Cl. G06F 15/16

(52) U.S. Cl. 709/249; 709/246

(57) ABSTRACT

Interoperability is facilitated between two networks. One method according to the present invention comprises: providing a VHN network having a VHN element; providing a HAVi network having a HAVi element; translating messages via a protocol translator coupled with the VHN network and the HAVi network; wherein interoperability is facilitated between the HAVi element and the VHN element.

### CROSS-REFERENCES TO RELATED APPLICATIONS

This invention derives priority from U.S. Provisional Patent Application No. 60/181,406, filed Feb. 9, 2000 and entitled “HAVi-VHN Bridge Solution,” which is incorporated herein in its entirety for all purposes.

### BACKGROUND OF THE INVENTION

A typical home audio/video (AV) equipment set-up includes a number of components. For example, a radio receiver, a compact disc (CD) player, a pair of speakers, a television (TV), a video cassette recorder (VCR), a tape deck and the like. Each of these components are connected to each other via a set of wires. One component is usually the central component of the home AV system. This is usually the radio receiver or the tuner of the radio receiver. The tuner has a number of specific inputs for coupling the other components. The tuner has a corresponding number of control buttons or control switches which provide a limited degree of controllability and interoperability for the components. The control buttons and control switches are usually located on the front of the tuner. In many cases, some or all of these buttons and switches are duplicated on a hand-held remote control unit. A user controls the home AV system by manipulating the buttons and switches on the front of the tuner, or alternatively, manipulating buttons on the hand-held remote control unit.

This conventional home AV system paradigm has become quite popular. As consumer electronic (CE) devices become more capable and more complex, the demand for the latest and most capable devices has increased. As new devices emerge and become popular, the devices are purchased by consumers and “plugged” into their home AV systems. Generally, the latest and most sophisticated of these devices are quite expensive (e.g., digital audio tape recorders, digital video disc (DVD) players, digital camcorders and the like). As a consumer purchases new devices, most often, the new device is simply plugged into the system alongside the pre-existing, older devices (e.g., cassette tape deck, CD player and the like). The new device is plugged into an open input on the back of the tuner, or some other device coupled with the tuner. The consumer (e.g., the user) controls the new device via the control buttons on the tuner, via the control buttons and control switches on the front of the new device itself, or via an entirely new, separate, respective remote control unit for the new device.

As the number of new CE devices for the home AV system has grown and as the sophistication and capabilities of these devices have increased, a number of problems with the conventional paradigm have emerged. One such problem is incompatibility between devices in the home AV system. CE devices from one manufacturer often couple with an AV system in a different manner than similar devices from another manufacturer. For example, a tuner made by one manufacturer may not properly couple with a TV made by another manufacturer.

In addition, where one device is much newer than another device additional incompatibilities may exist. For example, a new device might incorporate hardware (e.g., specific inputs and outputs) which enables more sophisticated remote control functions. This hardware may be unusable with older devices within the system. As another example, older tuners may lack suitable inputs for some newer devices (e.g., mini-disc players, VCR's, etc.), or may lack enough inputs for all devices of the system.

Another problem is the lack of functional support for differing devices within the home AV system. For example, even though a TV may support advanced sound formats (e.g., surround sound, stereo, etc.), if an older less capable tuner does not support such functionality, the benefits of the advanced sound formats can be lost.

Yet another problem is the proliferation of controls for the new and differing devices within the home AV system. For example, similar devices from different manufacturers can each have different control buttons and control switch formats for accomplishing similar tasks (e.g., setting the clock on a VCR, programming a VCR to record a program, and the like). In addition, each new device coupled with the AV system often leads to another dedicated remote control unit for the user to keep track of and learn to operate.

Standards have been developed for the home AV system which aim to correct the interoperability and functionality problems of the conventional system. These standards include the Home Audio/Video Interoperability (HAVi) Architecture and the Video Electronics Standards Association (VESA) Home Network, or VHN.

### SUMMARY OF THE INVENTION

In an embodiment of a method according to the present invention, interoperability is facilitated between two networks. The method comprises: providing a VHN network having a VHN element; providing a HAVi network having a HAVi element; translating messages via a protocol translator coupled with the VHN network and the HAVi network; wherein interoperability is facilitated between the HAVi element and the VHN element

In an embodiment of a method according to the present invention, interoperability is facilitated between two networks. The method comprises: providing a VHN network having a VHN element; providing a HAVi network having a HAVi element; providing a protocol translator coupled with the VHN network and the HAVi network; and controlling the at least one VHN element with the at least one HAVi element.

In an embodiment of a computer-readable media according to the present invention, interoperability is facilitated between a VHN network having a VHN element and a HAVi network having a HAVi element. The computer-readable media comprises: providing instructions for coupling the VHN network with the HAVi network; and providing instructions for facilitating interoperability between the HAVi element and the VHN element.

In an embodiment of a system according to the present invention, interoperability is facilitated between two networks. The system comprises: a VHN network having a VHN element; a HAVi network having a HAVi element; and a protocol translator coupled with the VHN network and the HAVi network; wherein the protocol translator facilitates interoperability between the HAVi element and the VHN element.

### BRIEF DESCRIPTION OF THE DRAWINGS

FIG. 1 is an illustration of a computer system suitable for use with the present invention.

FIG. 2 shows subsystems in the computer system of FIG. 1.

FIG. 3 depicts the arrangement of software elements on a HAVi FAV device.

FIG. 4 is a basic VHN device-to-device control model.

FIG. 5 illustrates a VHN network coupled with a HAVi network.

FIG. 6 illustrates FIG. 5 in greater detail.

FIG. 7 is a flow diagram of a new device being plugged into a HAVi network.

FIG. 8 is a flow diagram of a VHN application controlling a HAVi device.

FIG. 9 is a flow diagram of a VHN application controlling a HAVi application.

FIG. 10 is a flow diagram of a VHN device controlling a HAVi device. FIG. 10 is also a flow diagram of a VHN device controlling a HAVi application.

FIG. 11 is a flow diagram of a HAVi application controlling a VHN device.

FIG. 12 is a flow diagram of a HAVi application controlling a VHN application.

FIG. 13 is a flow diagram of a HAVi device controlling a VHN device.

FIG. 14 is a flow diagram of a HAVi device controlling a VHN application.

### DESCRIPTION OF THE SPECIFIC EMBODIMENTS

As shown in the exemplary drawings wherein like reference numerals indicate like or corresponding elements among the figures, an embodiment of a system according to the present invention will now be described in detail. The description describes an exemplary apparatus suitable to implement an embodiment of the present invention. Methods of operation and associated user interface details in accordance with the invention are also provided.

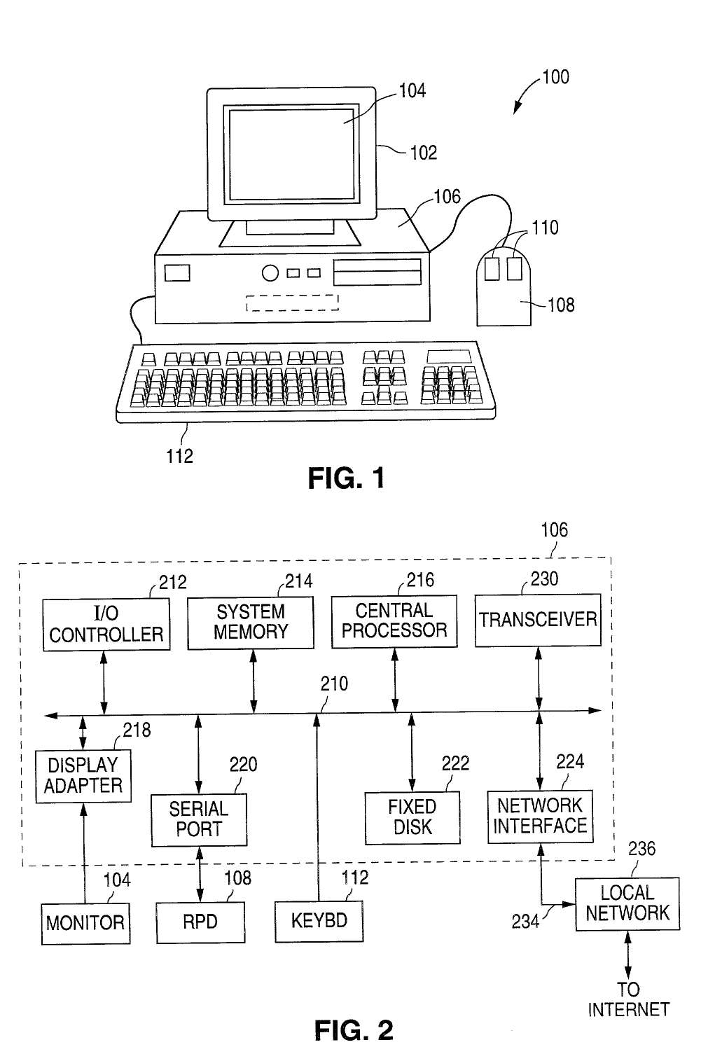

FIG. 1 shows a computer system 100 suitable for use to provide a system in accordance with the present invention. The computer system 100 includes a display 102 having a display screen 104 (the display may be a digital television (DTV) or personal digital assistant (PDA)-like device, etc.). A cabinet 106 houses standard computer components (not shown) such as a disk drive, CD-ROM drive, display adapter, network card, random access memory (RAM), central processing unit (CPU) and other components, subsystems and devices (since these inventions talk about a home network, 106 may be a STB (set top box) and not a standard PC). User input devices such as a mouse 108 having buttons 110, and a keyboard 112 are shown (another input device may be a two-way remote controller, a PDA-like device or a Sony Airboard device). Other user input devices such as a trackball, touch-screen, digitizing tablet, etc., can be used. In general, the computer system 100 is illustrative of one type of computer system, such as a desktop computer, suitable for use with the present invention. Computers can be configured with many different hardware components and can be made in many dimensions and styles (e.g., laptop, palmtop, server, workstation and mainframe). Thus, any hardware platform suitable for performing the processing described herein is suitable for use with the present invention.

FIG. 2 illustrates subsystems found in the computer system 100. Subsystems within box 106 are directly interfaced to an internal bus 210. The subsystems include input/output (I/O) controller 212, system random access memory (RAM) 214, central processing unit (CPU) 216, display adapter 218, serial port 220, fixed disk 222, network interface adapter 224 and transceiver 230. The use of the bus allows each of the subsystems to transfer data among the subsystems and, most importantly, with the CPU. External devices can communicate with the CPU or other subsystems via the bus by interfacing with a subsystem on the bus. The monitor 104 connects to the bus through the display adapter 218. A relative pointing device (RPD) such as a mouse 108 connects through the serial port. Some devices such as keyboard 112 can communicate with the CPU by direct means without using the main data bus as, for example, via an interrupt controller and associated registers (not shown). The transceiver 230 can be coupled with a satellite system, cable system, telephone lines or any other system suitable for propagating information. The transceiver can include or be coupled with a communication interface, which can be coupled with bus 210.

FIG. 2 is illustrative of one suitable configuration for providing a system in accordance with the present invention. Subsystems, components or devices other than those shown in FIG. 2 can be added without deviating from the scope of the invention. A suitable computer system can also be achieved without using all of the subsystems shown in FIG. 2. Other subsystems such as a CD-ROM drive, graphics accelerator, etc., can be included in the configuration without affecting the performance of the system included in the present invention.

The invention is related to the use of apparatus, such as the computer system 100, for implementing a scalable pay-by-time technique for the secure multicast distribution of streaming content, including, but not limited to, video and audio. According to one embodiment of the invention, multicast distribution is provided by the computer system 100 in response to the processor 216 executing one or more sequences of one or more instructions contained in the system memory 214. Such instructions may be read into memory 214 from a computer-readable medium, such as a fixed disk 222. Execution of the sequences of instructions contained in the memory 214 causes the processor to perform the process steps described herein. One or more processors in a multi-processing arrangement may also be employed to execute the sequences of instructions contained in the memory. In alternative embodiments, hard-wired circuitry may be used in place of or in combination with software instructions to implement the invention. Thus, embodiments of the invention are not limited to any specific combination of hardware circuitry and software.

The terms “computer-readable medium” and “computer-readable media” as used herein refer to any medium or media that participate in providing instructions to the processor 214 for execution. Such media can take many forms, including, but not limited to, non-volatile media, volatile media and transmission media. Non-volatile media include, for example, optical or magnetic disks, such as a fixed disk 222. Volatile media include dynamic memory, such as memory 214. Transmission media include coaxial cables, copper wire and fiber optics, including the wires that comprise the bus 210. Transmission media can also take the form of acoustic or light waves, such as those generated during radio frequency (RF) and infra-red (IR) data communications. Common forms of computer-readable media include, for example, a floppy disk, a flexible disk, a hard disk, magnetic tape, any other magnetic medium, a CD-ROM disk, DVD, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 216 for execution. For example, the instructions may initially be borne on a magnetic disk of a remote computer. The remote computer can load the instructions into its dynamic memory and send the instructions over a telephone line using a modem. A modem local to the computer system 100 can receive the data on the telephone line and use an infrared transmitter to convert the data to an infrared signal. An infrared detector coupled with the bus 210 can receive the data carried in the infrared signal and place the data on the bus. The bus carries the data to the memory 214, from which the processor retrieves and executes the instructions. The instructions received by the memory can optionally be stored on the fixed disk 222 either before or after execution by the processor.

The computer system 100 also includes a network interface 224 or communication interface coupled to the bus 210. The network interface or communication interface provides a two-way data communication coupling with a network link 234 that is connected to a local network 236. For example, the network interface or communication interface can be an integrated services digital network (ISDN) card or a modem to provide a data communication connection to a corresponding type of telephone line. As another example, the network interface or communication interface can be a local area network (LAN) card to provide a data communication connection to a compatible LAN. Wireless links can also be implemented. In any such implementation, the network interface 224 or the communication interface and transceiver 230) send and receives electrical, electromagnetic or optical signals that carry digital data streams representing various types of information.

The network link 234 typically provides data communication through one or more networks to other data devices. For example, the network link can provide a connection through the local network 236 to a host computer or to data equipment operated by an Internet Service Provider (ISP). The ISP in turn provides data communication services through the worldwide packet data communication network, now commonly referred to as the “Internet.” The local network and the Internet both use electrical, electromagnetic or optical signals that carry digital data streams. The signals that propagate through the various networks and the signals on the network link and that propagate through the network interface 224, and the signals that propagate through the transceiver 230, which carry the digital data to and from computer system 100, are exemplary forms of carrier waves transporting the information.

The computer system 100 can send messages and receive data, including user commands, video data, audio data and program codes through the network(s), the network link 234, and the network interface 224. In the Internet example, a server might transmit a requested code for an application program through the ISP, Internet, local network 236 and network interface 224. Instead of or in addition to transmission via the Internet, the computer system 100 can send and receive data via the transceiver 230 and a wireless system, satellite system, cable system, telephone lines or any other system suitable for propagating information between the computer system and an information distribution system. In accordance with the invention, one such downloaded application provides for a scalable pay-by-time technique for secure multicast distribution of streaming content as described herein. The processor 216 can execute the received code as the code is received, and/or store the code on the fixed disk 222, or other non-volatile storage for later execution. In this manner, the computer system can obtain an application code in the form of a carrier wave.

It is contemplated that various hardware components can be added to the present system. Some examples of these components include set-top boxes, interactive televisions and mobile devices.

Unless specifically stated otherwise or apparent from the following discussion, one should appreciate that terms such as “computer,” “compute,” “computed,” “computing,” “processor,” “process,” “processed” “processing,” “memory” or the like, can refer to the parts, actions and processes of an intelligent device such as a computer system, set-top box, digital television or the like. Moreover, the computer system 100 can refer to any CE device that provides a computer system platform. Some examples of such CE devices include set-top boxes (STB's), DTV's, general purpose home control devices and personal computers (PC's), which are known in the art.

The HAVi architecture, mentioned above, is intended for implementation on computing devices and CE devices. HAVi, which is known in the art, provides a set of services which facilitate interoperability and the development of distributed applications on home networks. HAVi is a software architecture that allows new devices to be integrated into the home network and to offer their services in an open and seamless manner. The types of devices supported by HAVi include, but are not limited to: DTV, set-top box, DVD, tuner, VCR, clock, camera, AV disc, display, amplifier, modem, Web proxy and converter. HAVi devices are Institute of Electrical and Electronics Engineers (IEEE) 1394 enabled.

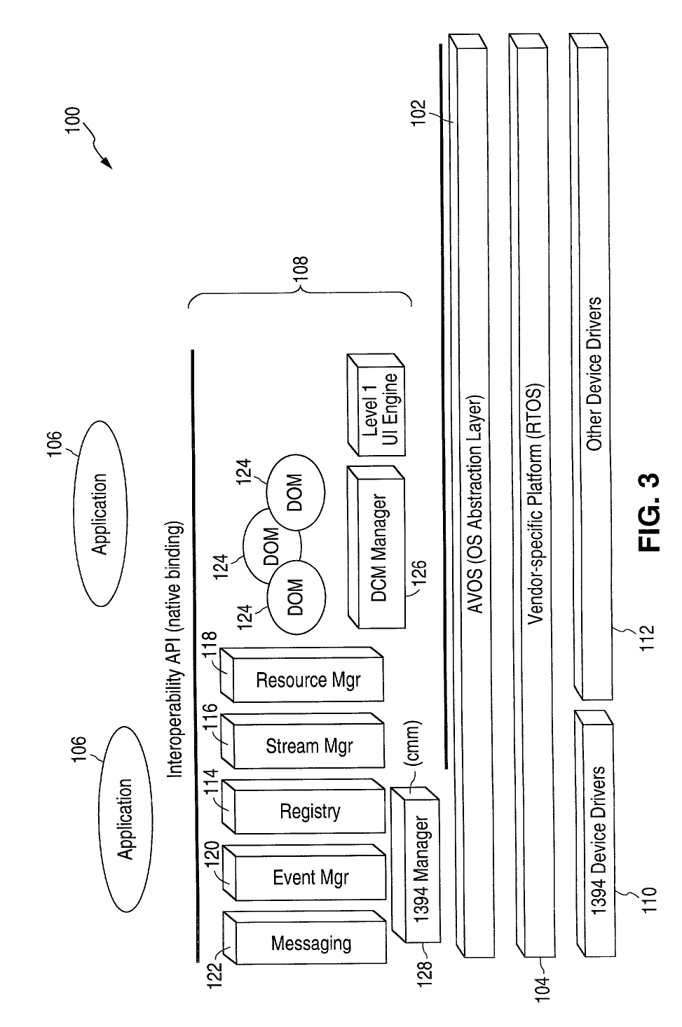

Referring to FIG. 3, the arrangement of software elements 100 on a HAVi Full AV (FAV) Device is depicted. Collectively, these software elements expose the Interoperability Application Programming Interface (API), a set of services for building portable distributed applications on the home network. The following is a general description of the HAVi Architecture. The Audio/Video Operating System (AVOS) 102 is a portability layer on top of the vendor-specific platform 104 (e.g., RTOS or Windows CE). The AVOS acts as a portability layer by allowing a change of vendor platform without the need to rewrite the upper layer applications 106 and middleware 108. Below the vendor-specific platform lie the 1394 device drivers 110 and other device drivers 112.

When an application in a HAVi environment wants to find out about what kind of network devices or network services are available, the application goes to the registry 114. Software elements describe themselves to the registry. Applications can go to the registry to find out what those software elements are. It is a way to implement discovery. The stream manager 116 is responsible for setting up streams of data. For example, the stream manager may stream video from a hard disc drive to a TV.

The resource manager 118 is responsible for scheduling resources. For example, tells devices when to turn on or off, or to play loudly or softly. Basically, the function of a resource manager is analogous to that of a conductor of a symphony. The event manager 120 acts as an event mechanism. An application may be interested in when an asynchronous event occurs. The event manager generates an event at appropriate times (e.g., when a TV turns on or off).

The messaging system 122 is a conduit for messages to be passed through. The messaging system communicates with the event manager 120, the stream manager 116 and device control modules (DCM's) 124. DCM's are conceptually central to the HAVi architecture and the source of flexibility in accommodating new features and devices. DCM's act as software proxies. There is one DCM present in a HAVi system per device. In order to communicate with a given device, an application or other device communicates with the DCM, which in turn communicates with the given device using the appropriate protocol proprietary to the given device.

The DCM manager 126 is responsible for loading, instantiating and removing DCM's 124 from the system. The DCM manager oversees the installation and removal of DCM's. For, example, if a system included a TV, a hard drive and two set-top boxes, the DCM manager would determine on which the devices the various DCM's would run. The DCM manager would load the byte code from the configuration ROM of the BAV devices and create DCM's within one or both of the set-top boxes. There would only be one DCM created per device that is going to be controlled. The DCM manager oversees the DCM installation and makes sure that only one DCM is running per device that is going to be controlled. The DCM manager decides which FAV or IAV device stores each DCM.

Intermediate AV devices (IAV's) and Base AV devices (BAV's) are also part of a typical HAVi system. IAV devices are generally lower in cost than FAV devices and more limited in resources. IAV devices do not provide a runtime environment for Java bytecode and so cannot act as controllers for arbitrary devices within the home network. However, an IAV may provide native support for control of particular devices on the home network.

A BAV device is a “dumb” device (e.g., a printer) that provides uploadable Java bytecode, but does not host any of the software elements of the HAVi architecture. The control information for the BAV device is stored on configuration read-only memory (ROM) within the device. This information relates to how to control the BAV device and how it talks to other BAV devices can be controlled by an FAV device via the uploadable bytecode or from an IAV device via native code. The protocol between the BAV device and the BAV software proxy may or may not be proprietary. Communication between an FAV or IAV device and a BAV device requires that HAVi commands be translated to and from the command protocol used by the BAV device.

A device (e.g., TV, camera, set-top box, stereo system, MP3 player) can be controlled (e.g., turn on, turn off, play, fast-forward) by commands. Those commands can be in Java bytecode, which can live inside the configuration ROM of the device itself. The DCM manager 126 reads the byte code in the configuration ROM of a BAV device and creates the DCM for the BAV device. When an entity tells the DCM to, say, power on, the DCM tells the corresponding device to power on. The DCM sends a control sequence (a command packet) over an IEEE 1394 bus, wireless connection, etc.

The function of the 1394 communication media manager (CMM) 128 is to manage communications and put the bits on the wires. In use, when a CE device is plugged into the HAVi network, the network creates a bus reset and sends this signal on the 1394 bus to all devices on the bus. The CMM detects the bus reset and sends a new CE device event to the DCM manager 126. This happens through the event manager 120. Any device can register with the event manager and will subsequently be informed when a new device is on the bus. The CMM then reads the configuration ROM and retrieves a DCM code unit. The CMM causes the code unit to install the DCM 124. Subsequently, the DCM 124 registers with the messaging system 122 and the registry 114.

A HAVi application 106 that has initialized itself and is running registers with the messaging system 122 so that it can communicate with other processes. The event manager 120 notifies a HAVi application that is running of a new device on the bus. The HAVi application can go to the registry 114 to find out if there is a device that it wants to control (e.g., VCR, TV, etc.). Let us assume the application is looking for a VCR to control. The application may find the VCR and gets the software handle from the registry. The application is now able to communicate with the DCM for the VCR. The HAVi application module can talk to the resource manager 118 and give instructions to, for example, turn on the VCR at 10:00 p.m. and record.

Furthermore, the DCM manager 126 is notified by the event manager 120 that there is a new device on the bus. The DCM manager reads the profile in the configuration ROM and reads the self-describing data (SDD) to find out what the device is. The DCM manager decides on a DCM host for the DCM of the new device and then loads the DCM. The HAVi application 106 may do discovery and go into the registry 114 and discover the new DCM was loaded. The HAVi application may then decide to control the new device (e.g., set the clock on the device, the device being a VCR).

The VHN architecture, mentioned above, allows for the recognition and interoperability of multiple home network devices. This interoperability enables consumers to access all their networked appliances through devices such as their PC or TV. VHN utilizes Internet technologies to seamlessly connect all home devices, while providing remote device control using any Web browser. Using Internet protocols, the VHN network provides the capability to couple different network technologies together under one completely supported system.

A graphical user interface (GUI) for a VHN system may consist of a plurality of icons displayed on a computer or TV screen. When a user selects an icon, the HTML pages are retrieved from the configuration ROM of the device in question. The HTML pages are displayed for the user. This allows the user to control the given device.

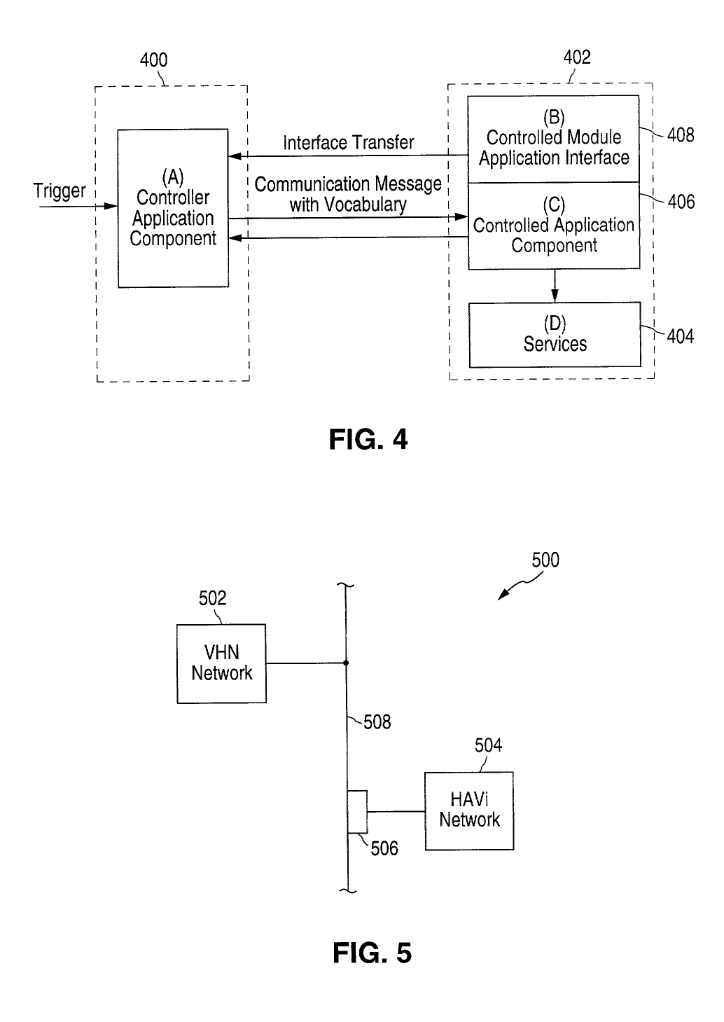

Referring to FIG. 4, a basic VHN device-to-device control model is shown. The figure shows a controller module 400 and a controlled module 402. The controller module can discover the controlled module and control the services 404 of the controlled module. The controlled application component 406, an embedded executable software in the controlled module, has direct control over the services. The controlled module application interface 408 describes the controllable services and interface of the controlled application component.

If a device-to-device control process is triggered, the controller module 400 will first attempt to discover the controlled module 402. After the controller module has discovered the interface of the controlled module, it can send commands thereto. This generates an acknowledgment and/or machine action of the services 404. VHN allows the use of Web technology (XML) for the message and interface formats. A home network broker and interface repository (HNB & IR) can be located in any third device, or in a separate, dedicated device. The HNB & IR is a software agent that helps one device discover other devices and what their commands are, among other things.

When a device first comes online it registers with the HNB & IR, revealing the type of device it is and the commands that the device supports. If the controller module 400 wants to control the controlled module 402, the controller module first has to go through discovery. Therefore, the controller module reads the HNB & IR and discovers the controlled module (e.g., that of a VCR) and also the commands it needs to communicate with or control the VCR. The controller module obtains the handle (IP address) for the controlled module. The controller module can now talk to the VCR and send commands through an XML-based remote procedure call (RPC).

In accordance with embodiments of the present invention, FIG. 5 illustrates a network 500 comprising a VHN network 502 and a HAVi network 504. The VHN network and the HAVi network each comprise at least one element. The elements can include devices and application. Interoperability is facilitated between the VHN network and the HAVi network by providing a protocol translator 506 coupled with the VHN network and the HAVi network, all of which are coupled to an IEEE 1394 bus 508 or other suitable bus. The protocol translator 506 can physically or logically be on the some device as the HAVi controller 504. The protocol translator, or bridge, allows for controlling a HAVi element (device or application) with a VHN element (device or application).

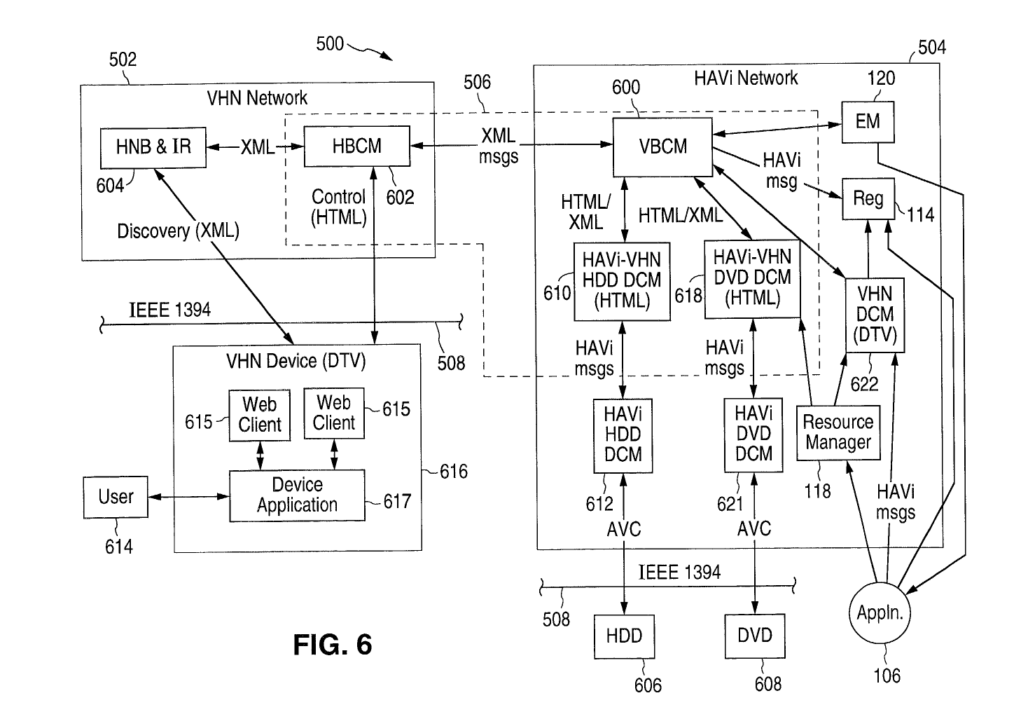

Turning now to FIG. 6, FIG. 5 is shown in greater detail. A VHN bridge control manager (VBCM) 600, does handshaking and protocol conversion between the HAVi and VHN networks. The HAVi bridge control manager (HBCM) 602, talks to the HNB & IR 604 in behalf of the HAVi network. The HBCM 602 and the VBCM 600 together comprise the protocol translator 506, converting HAVi messages into XML messages and converting XML messaging into HAVi messages (as well as other things). The HAVi-VHN DCM's 610, 618 (described below) may or may not be considered a part of the protocol translator. The HNB & IR knows which devices are on the VHN network and the HAVi network providing the VBCM is fully operational. Likewise, the HAVi registry knows which devices are on the HAVi network and the VHN network providing the HBCM is fully operational. In order for this to happen it is up to individual VHN devices to inform the HNB & IR of its presence in the VHN network and individual HAVi devices to inform the HAVi registry of its presence in the HAVi network. Otherwise the HNB & IR and HAVi registry will not know when devices come, go and change state. The HBCM constantly monitors the HNB & IR for new VHN devices so that the HAVi network 504 can know when to instantiate the respective HAVi-VHN DCM and it can register the VHN device with the HAVi registry. If a VHN device is removed from the network, the HBCM will notify the VBCM which will in turn remove the respective HAVi-VHN DCM. This is done to free memory.

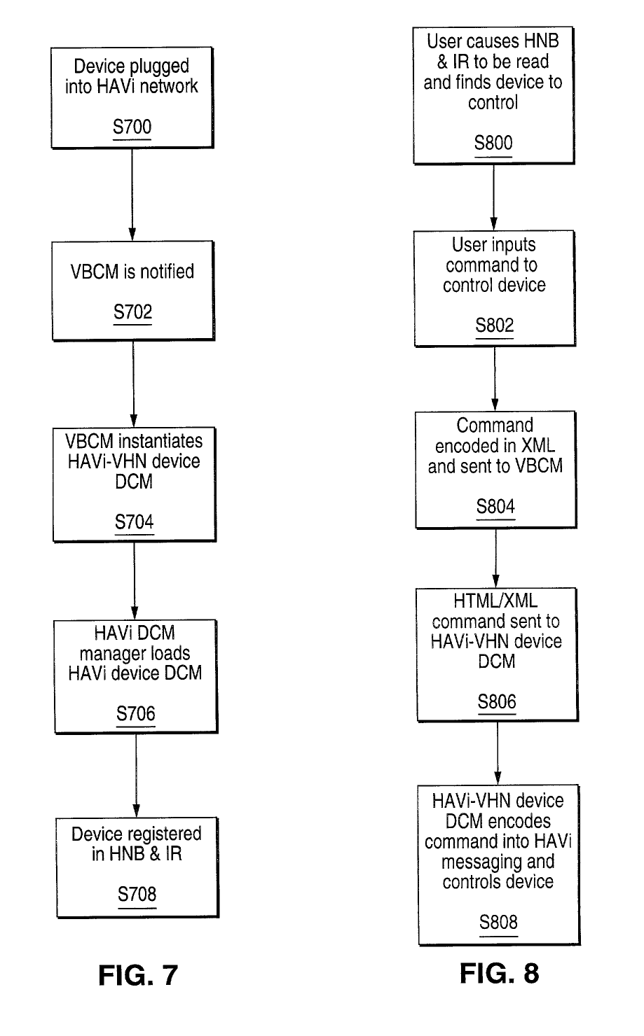

As shown in FIG. 7, when a new device, such as hard disc drive (HDD) 606 or DVD player 608, comes on the HAVi network 504 (step S700), a bus reset is generated. At S702, the DCM manager loads the HAVi DCM, and the DCM instantiates itself. At S704, the DCM (and corresponding FCMs) registers with the HAVi messaging system and the registry 114. At S706, the HAVi event manager 120 notifies the VBCM 600 of the event (the new DCM). At S708, the VBCM instantiates the HAVi-VHN device DCM and sends a message to the HBCM 602. The HBCM configures the new HAVi device into the VHN network and returns an IP address to the VBCM (the IP address will be used to reference the HAVi device in the VHN network). The returning of the IP address signifies that the HBCM successful configured the HAVi device in the VHN network. The VBCM uses the IP address in the protocol conversion and passes it to the HAVi-VHN device DCM.

Turning to FIG. 8, at step S800, after a DVD 608 is connected, a user from the VHN network can access the HAVi DVD device. This discover occurs by accessing the HNB & IR 604. Control of the DVD player is through the VHN application's Web browser 615 and accessing the VHN BCM, and the device application 617. The Web client pulls the HTML page out and HAVi-VHN DCM, thereby allowing the user to control the DVD player. At step S802, the user selects a “play” icon on the DTV 616. At step S804, the play command is encoded in XML and sent to the VBCM 600. At step S806, the VBCM in turns sends an HTML/XML command to the respective HAVi-VHN DVD DCM 618. HAVi does not know how to interpret XML or HTML as HAVi does not use these protocols. The HAVi-VHN DVD DCM 618 knows the HAVi protocols as well as the VHN protocols.

At step S808, the HAVi-VHN DVD DCM 618 encodes the XML commands from the VHN network into a HAVi messages because the HAVi DVD DCM 621 only knows HAVi messaging. Therefore, the VHN protocol has been mapped into HAVi messaging that the HAVi DVD DCM understands. The DVD player can thus be controlled by the HAVi DVD DCM. Consequently, we have a VHN application on the VHN network 502 controlling a HAVi device.

### HAVi Startup Process

Before a HAVi application or device can become “HAVi aware,” it must go through the HAVi startup process. In part, this means the application or device registers with the HAVi messaging system to obtain a software element identification (SEID) which is a globally unique identification in the HAVi network. The SEID is used in the HAVi system to allow other HAVi or VHN processes to access the application or device. Next the application or device must describe itself to the HAVi registry 114. Afterwards the application is free to use any HAVi services. This same process must be followed for VHN devices or applications that want to interface to the HAVi network. This means VHN processes wishing to operate in the HAVi network must obtain a valid SEID and register with the HAVi registry.

### The VHN Bridge Control Manager (VBCM)

The main function of the VBCM 600 is to expose HAVi devices to the VHN network and VHN devices to the HAVi network 504. When the VBCM first initializes, it registers with the HAVi event manager 120 and request that all events related to new/gone device/application. When the VBCM receives notice (an event) of new devices or applications (an asynchronous event), it queries the HAVi registry 114 to determine their services. When the VBCM finds a HAVi device or application it creates a HAVi-VHN DCM. The VBCM indirectly gets an IP address (using VHN's DHCP services) and assignes it to the HAVi-VHN DCM (getting the IP address is actually done by the HBCM). This is so the HAVi-VHN DCM's can send and receive XML messages to the VHN network. The HAVi-VHN DCM's may contain HTML pages to represent the devices' services. If so, the HTML pages can be downloaded from the World Wide Web (WWW) or contained in the devices configuration ROM, or from other resources (e.g., a diskette or memory card that ships with device, etc).

After a HAVi-VHN DCM is created, the VBCM sends an XML message to the HAVi BCM notifying it of a new HAVi device or application. The XML message to the HAVi BCM is descriptive information about the HAVi device or application (model, device type, device manufacturer, etc.) and a unique identifier (SEID). This information will be used by the HAVi BCM to register HAVi devices or applications in the VHN network. When the HAVi BCM successfully configures the HAVi device, it returns an IP address to the VBCM. The IP address is used to reference the HAVi device in the VHN network. Lastly, the VBCM passes the IP address to the HAVI-VHN DCM where it will be used to cross reference HAVi messages and XML messages. Without this process, HAVi devices or applications would not be discovered in a VHN network.

Likewise, when the new VHN devices or applications are detected by the HAVi BCM, the VBCM 600 will receive a message from the HBCM. It is the responsibility of the VBCM to register the VHN device or application with the HAVi messaging system and registry. In turn, a SEID value is generated for the VHN device or application. The SEID is used to register the VHN device or application with the HAVi registry 114. The registry will be given sufficient information about the VHN device or application so that the VHN device or application can be discovered in a HAVi network.

Finally, a HAVi-VHN DCM is created for the VHN device or application. This is necessary for VHN devices or applications to communicate with HAVi devices and for HAVi devices (or application) to communicate with VHN device. The HAVi-VHN DCM will translate XML messages into HAVi messages and HAVi messages into XML messages. Without this process, VHN devices or applications would not be discovered in a HAVi network.

A final note about the VBCM that needs to be pointed out is that it must support all the VHN Internet protocols which make it possible to interface into the VHN network. This means it will support TCP/IP and Web protocols. It will use the IP over IEEE 1394 protocol to send and receive XML messages to/from the VHN network. Also, it will contain a web server that is able to send HTML pages to VHN processes. Likewise, it will contain a modified web browser that is able to receive HTML pages and translate them into HAVi messages, Java UI (AWT), or DDI objects. In some situation, it is possible the HAVi-VHN DCMs may contain these and other protocols. This will allow the DCM to interface directly with the VHN devices without the aid of the HBCM and VBCM. However, in order to keep the system light (use less memory) it is desirable to keep the VHN protocols in the VBCM and have the HAVI-VHN DCM's use the services of the VBCM as needed.

### The HAVi Bridge Control Manager (HBCM)

When the HBCM 602 is notified of a new HAVi device (or application) by the VHN BCM, it creates an IP address for the device using an available DHCP server. A map between the IP address and the SEID are maintained by the HBCM and VBCM independently of one another. This is used to cross-reference a HAVi device when it is being referenced in the VHN network as well as a VHN device when it is being used in the HAVi network.

When the HAVi BCM is notified of a new HAVi application or device, it registers the information with the HNB & IR 604. This means passing an XML message that contains the IP address (and possibly the SEID) and a description of the HAVi device or application to the HNB & IR. Some of the device or application descriptive information may contain basic information, such as the device model, device features and a user-configurable device name. Other device manufacture-specific information may be included with the device information (i.e., device features, device software version, etc.). Without this process, a HAVi device or application would not be discovered in a VHN network.

The HBCM 602 is responsible for notifying the HAVi system of VHN processes (new and gone). This is accomplished by the HAVi BCM's ability to detect IEEE 1394 bus resets that helps it detect new VHN devices. Once a bus reset is detected, the HAVi BCM queries the HNB & IR 604 to discover new/gone VHN devices. In some situations VHN devices will not operate on the IEEE 1394 networks. In this case the HAVi BCM cannot dynamically detect VHN devices (or applications), so it is must periodically poll the HNB & IR to discover new/gone devices. There may be special situations where the HAVi BCM has to interface into VHN Backbone Component Interface (BCI) devices to obtain end device information or state conditions. These situations would occur when end device or BCI devices are unable to report to the HNB & IR.

Once the HAVi BCM discovers a new VHN device (either by the HNB & IR or a BCI device), it will send a XML message to the VHN BCM requesting the VHN devices be configured and registered in the HAVi system. This will result in the VHN BCM registering the VHN device with the HAVi messaging system and returning a HAVi SEID. Also, the VHN BCM will register the VHN device with the HAVi registry 114 and create a HAVi-VHN DCM. This will allow HAVi applications and devices to interface into the VHN network 502. The HAVi-VHN DCM will communicate to the VHN network over XML and RPC. When the configuration process is successful, the VHN BCM will send the SEID of the VHN device to the HAVi BCM signifying the registration process was completed. Without this process, a VHN device or application would not be discovered or operate in a HAVi network.

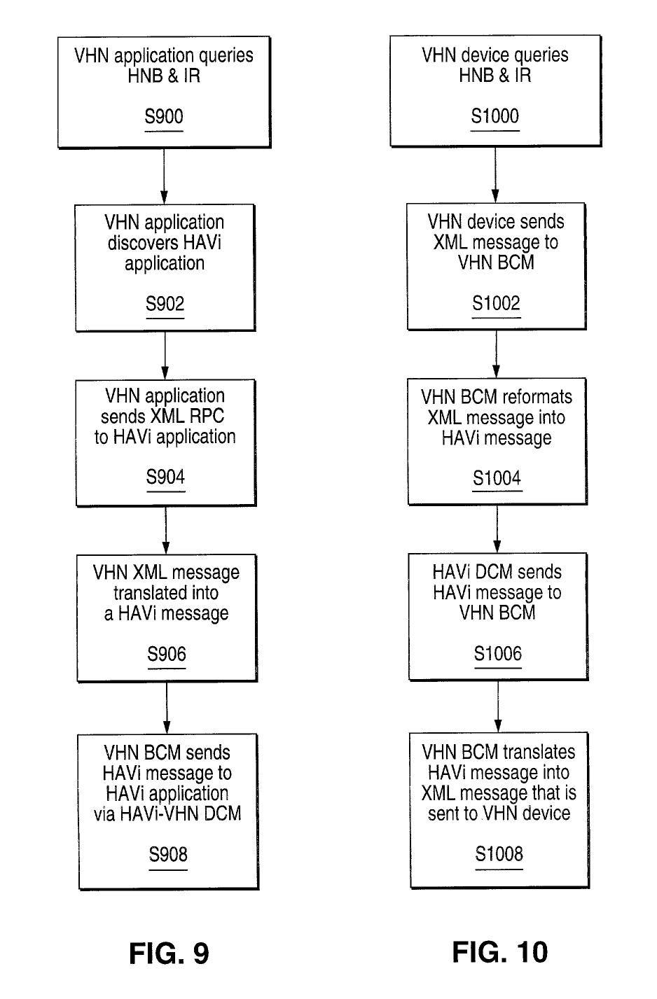

In one embodiment, as shown in FIG. 9, a VHN application can control a HAVi application. The VHN application queries the HNB & IR 604 to discover a HAVi application 106, at S900 and S902. The HNB & IR will return the IP address (and possible the SEID) of the HAVi application. When the VHN application sends an XML RPC to the HAVi application, at S904, it will be picked up by the HAVi VHN BCM (HAVi-VHN DCM). In turn, the VHN XML message will be translated into a HAVi message using the SEID of the HAVi application, at S906. Furthermore, the VHN BCM (via the HAVi-VHN DCM) sends the HAVi message to the HAVi application, at S908.

When the HAVi application 106 responds back to the VHN application, it does so using the VHN SEID address that was encoded into the HAVi message. The VHN BCM translates (via the HAVi-VHN DCM) the HAVi message into a XML RPC response using the assigned IP address of the VHN application.

Likewise, referring to FIG. 10, a VHN device 616 can control a HAVi device. Similar to the example above, the VHN device 616 queries the HNB & IR 604 for HAVi devices, at S1000. What is returned from the HNB & IR is the IP address (and possibly the SIED) of the HAVi device. The VHN device is free to send XML messages (using the assigned IP address of the HAVi device) to the VHN BCM (via the HAVi-VHN DCM), at S1002. The VHN BCM recognizes the IP address of the VHN device 616 and reformats the XML message into a HAVi message that will be sent to the HAVi DCM (via the HAViVHN DCM), at S1004.

The response from the device's HAVi DCM will send a HAVi message to the VHN BCM (HAVi-VHN DCM) using its mapped SEID address, at S1006. This will cause the VHN BCM to translate the HAVi message into a XML message that will be sent to the VHN device, at S1008. The SEID and IP address of the devices will be used to cross-reference each device (VHN and HAVi).

Similarly, a VHN device 616 can control a HAVi application 106. The only difference between this case and the one above is that the VHN device uses the HAVi application IP address which is obtained from the HNB & IR. The VHN BCM will translate the IP address of the HAVi application into the respective SEID. Everything else is the same, and is shown in FIG. 10.

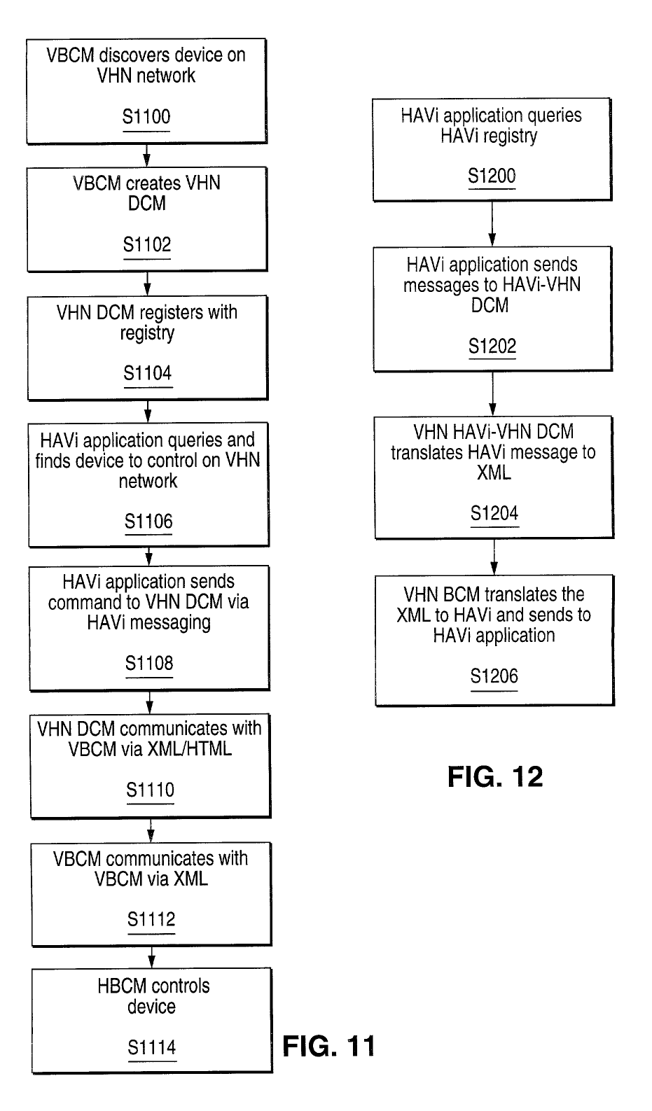

Still referring to FIG. 6, in other embodiments according to the present invention, the HAVi application 106 can control a device (e.g., the DTV 616) on the VHN network 502. Referring to FIG. 11, as shown in steps S1100 and S1102, when the VBCM 600 discovers that there is a DTV on the VHN network, it creates the VHN DCM 622 (HAVi-VHN DCM). The VHN DCM can be considered to be a virtual DCM because the DTV physically resides on the VHN network and not the HAVi network.

Next, at step S1104, the VHN DCM 622 registers itself with the registry 114. At step S1106, the HAVi application 106, which is attempting to control a DTV, goes to the registry 114 and queries for all DTV's on the network. Subsequently, the HAVi application finds the DTV 616 SEID which enables it to control the DTV's respective DCM. The HAVi application does not have information that the DTV 616 is a VHN device.

At step S1108, the HAVi application 106 can now control the DTV 616 (e.g., turn it on or off, set the time, etc.) by sending commands to the VHN DCM 622 via HAVi messaging. The HAVi application thinks that it is talking to a HAVi DCM 124, using the HAVi protocols. Furthermore, any of the HAVi software modules that communicate with the VHN DCM 622 do so through HAVi messaging.

At step S1110, the VHN DCM 622 can now communicate with the VBCM 600 via XML and HTML. At step, S1112, the VBCM, in turn, communicates with the HBCM 602 in XML. The HBCM 602 thus controls the DTV 616, as shown in step S1114. The result is a HAVi application 106 running on a HAVi network 504 controlling a VHN device 616. In some situation, it the VHN DCM (HAVi-VHN DCM) can interface directly with the client application. This is done if the VHN DCM contains the IP protocols and web protocols. In this case, the VHN DCM using the IP over IEEE 1394 protocols to communicate with the VHN device.

In an alternate embodiment, referring to FIG. 12, a HAVi application 106 can control a VHN application. A HAVi application queries the HAVi registry for VHN applications (an SEID of the VHN application is returned), at S1200. Once the HAVi application obtains the SEID of the VHN application, it is free to send HAVi messages to the VHN application. The HAVi-VHN DCM translates the HAVi message to XML messages, at S1202 and S1204. The SEID of the VHN application is used to retrieve the VHN applications IP address. The XML message is transmitted using IP/1394.

The VHN application uses the IP address of the HAVi application when it sends a response. The VHN BCM (via the HAVi-VHN DCM) translates the XML message into a HAVi message and sends it to the HAVi application, at S1206.

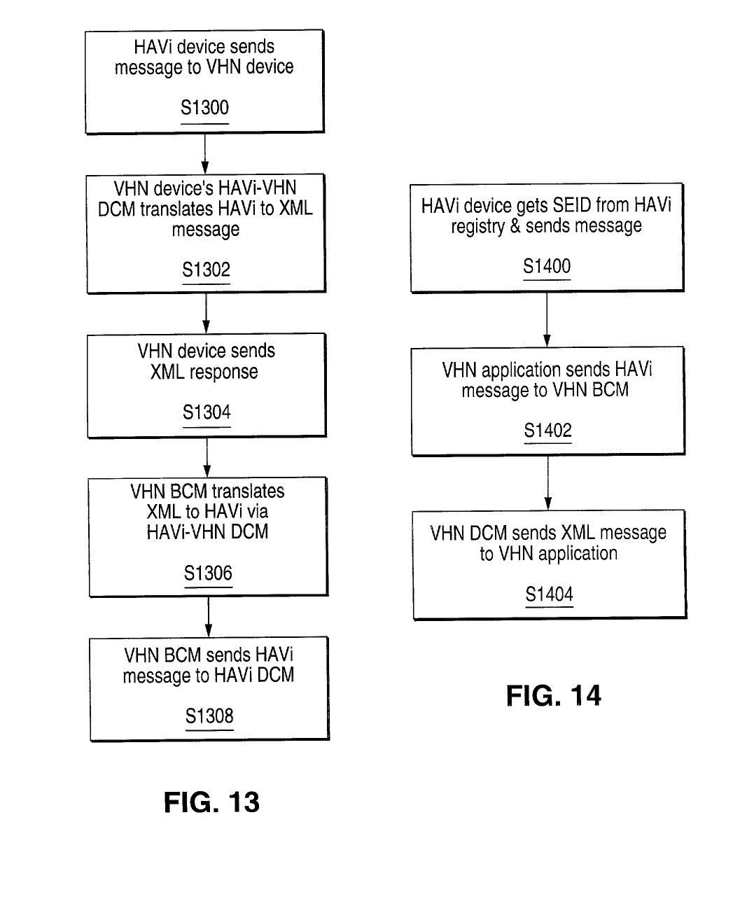

Moreover, a HAVi device can control a VHN device 616, as illustrated in FIG. 13. A HAVi device is able to control a VHN device by going to the HAVi registry 114 and getting the SEID of the VHN device. The HAVi device sends a message to the VHN device (via HAVi messaging), at S1300. The VHN device's HAVi-VHN DCM is able to receive the HAVi message and translate it into a XML message, at S1302. It maps the SEID address into the VHN devices IP address. When the VHN device 616 responds to the HAVi device it does so by sending an XML response, at S1304. The VHN BCM (via the HAVi-VHN DCM) translates the XML message into a HAVi message and sends it to the HAVi DCM, at S1306 and S1308.

In another embodiment, as shown in FIG. 14, a HAVi device can control a VHN application. A HAVi device can control a VHN device by getting its SEID from the HAVi registry 114 and sending it messages, at S1400. The HAVi device's DCM sends HAVi messages to the HAVi-VHN DCM which in turn sends XML messages to the VBCM, at S1402. The VBCM in turns sends XML messages to the VHN application, at S1404. When it comes time for the VHN application to respond to the HAVi device, it will send XML messages (using the IP address of the HAVi device) back to the VBCM. At this point, the message will be parsed and passed back to the HAVi-VHN DCM. The HAVi-DCM will reformat the VHN message into HAVi messages and pass them on to the HAVi DCM. At this point the HAVi DCM can send proprietary commands (i.e., AV/C commands) to the HAVi device.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method of facilitating interoperability between two networks, the method comprising:
providing a VHN network having a VHN element;
providing a HAVi network having a HAVi element; and
translating messages via a protocol translator coupled with the VHN network and the HAVi network;
wherein the interoperability is facilitated between the HAVi element and the VHN element.

2. The method of claim 1, wherein the protocol translator comprises:
a HAVi bridge control manager;
a VHN bridge control manager coupled with the HAVi bridge control manager; and
a HAVi-VHN DCM coupled with the VHN bridge control manager.

3. A method of facilitating interoperability between two networks, the method comprising:
providing a VHN network having a VHN element;
providing a HAVi network having a HAVi element;
providing a protocol translator coupled with the VHN network and the HAVi network; and
controlling the HAVi element with the VHN element.

4. The method of claim 3, wherein the protocol translator comprises:
a HAVi bridge control manager;
a VHN bridge control manager coupled with the HAVi bridge control manager; and
a HAVi-VHN DCM coupled with the VHN bridge control manager.

5. A method of facilitating interoperability between two networks, the method comprising:
providing a VHN network having a VHN element;
providing a HAVi network having a HAVi element;
providing a protocol translator coupled with the VHN network and the HAVi network; and
controlling the VHN element with the HAVi element.

6. The method of claim 5, wherein the protocol translator comprises:
a HAVi bridge control manager;
a VHN bridge control manager coupled with the HAVi bridge control manager; and
a HAVi-VHN DCM coupled with the VHN bridge control manager.

7. The method of claim 5, wherein controlling comprises controlling a HAVi device with a VHN device.

8. The method of claim 5, wherein controlling comprises controlling a HAVi device with a VHN application.

9. The method of claim 5, wherein controlling comprises controlling a HAVi application with a VHN device.

10. The method of claim 5, wherein controlling comprises controlling a HAVi application with a VHN application.

11. A computer-readable media for facilitating interoperability between a VHN network having a VHN element and a HAVi network having a HAVi element, the computer-readable media comprising:
providing instructions for coupling the VHN network with the HAVi network; and
providing instructions for facilitating interoperability between the HAVi element and the VHN element.

12. The computer-read able media of claim 1, wherein providing instructions for facilitating interoperability comprises:
providing instructions for a HAVi bridge control manager;
providing instructions for a VHN bridge control manager coupled with the HAVi bridge control manager; and
providing instructions for a HAVi-VHN DCM coupled with the VHN bridge control manager.

13. A system for facilitating interoperability between two networks, the system comprising:
a VHN network having a VHN element;
a HAVi network having a HAVi element; and
a protocol translator coupled with the VHN network and the HAVi network;
wherein the protocol translator facilitates interoperability between the HAVi element and the VHN element.

14. The system of claim 13, wherein the protocol translator comprises:
a HAVi bridge control manager;
a VHN bridge control manager coupled with the HAVi bridge control manager; and
a HAVi-VHN DCM coupled with the VHN bridge control manager.
